(19) United States
(12) Patent Application Publication
(10) Pub. No.: US 2006/0000148 A1
(43) Pub. Date: Jan. 5, 2006

(54) Weather strip and mounting structure thereof

(76) Inventors: Satoshi Mugishima, Aichi-ken (JP); Teruhito Goto, Aichi-ken (JP)

Correspondence Address: POSZ LAW GROUP, PLC, 12040 SOUTH LAKES DRIVE, SUITE 101, RESTON, VA, 20191, US

(21) Appl. No.: 11/159,262

(22) Filed: Jun. 23, 2005

(30) Foreign Application Priority Data
Jun. 30, 2004 (JP) P2004-192421

(51) Int. Cl. E06B 7/16

(52) U.S. Cl. 49/475.1

(57) ABSTRACT

A weather strip adapted to be mounted on a door of a vehicle: the weather strip has a mount base part including an interior-side engagement portion and an exterior-side engagement portion which are engageable with a pair of engagement recesses provided on a mount portion of a door. A neck portion extends from the interior-side engagement portion. A hollow seal part includes a bottom wall portion extending from the neck portion substantially linearly and substantially in parallel with the interior-side engagement portion of the mount base part. A predetermined space is formed between the bottom wall portion and the interior-side engagement portion. A seal wall is provided on a side of the bottom wall portion which is opposite to a surface of the bottom wall portion facing the interior-side engagement portion.

### BACKGROUND OF THE INVENTION

1. Field of the Invention

The present invention relates to a weather strip that is mounted on a door of a vehicle.

2. Related Art

Conventionally, a door weather strip is mounted on a peripheral portion of a door of a vehicle such as an automobile. The door weather strip includes a mount base part that is mounted on a retainer having a substantially C-shaped cross section that is provided along the peripheral portion of the door, and a hollow seal part and a seal lip which are formed integrally with the mount base part, and most of the weather strip is formed through a so-called extrusion. When the door is closed, the hollow seal part and the seal lip of the door weather strip are brought into pressure contact with a peripheral portion around a door opening in a body of the automobile (for example, refer to JP-H07-21413U).

In the event that a relatively large hollow seal part is extruded, however, there exists a risk that the hollow seal part sags after extrusion, whereby the hollow seal part and the mount base part are caused to attach to each other. In addition, even in the event that the two parts are successfully kept apart from each other, due to the hollow seal part sagging, the hollow seal part overhangs the mount base part, narrowing a gap between the two parts. Due to this, it becomes difficult to insert a fold back portion of the retainer into the gap between the hollow seal part and the mount base part, for engaging the fold back portion with an end portion of the mount base part. Namely, there has existed a risk that it becomes difficult to fit the mount base part in the retainer. Since the fitting of the mount base part must generally be performed by an assembling operator who relies not on sight but on touching, the aforesaid problem appears significantly.

### SUMMARY OF THE INVENTION

The invention was made with a view to solving the problems and objects thereof is to provide a weather strip in which assemble performance is improved, and a mounting structure of such the weather strip.

Hereinafter, inventive features which are suitable for attaining the objects will be itemized for description below. Note that functions and advantages inherent in the inventive features will be added as required after each description.

(1) A weather strip adapted to be mounted on a door of a vehicle, comprising:
a mount base part including an interior-side engagement portion and an exterior-side engagement portion which are engageable with a pair of engagement recesses provided on a mount portion of a door, and a neck portion extending from said interior-side engagement portion or a vicinity of said interior-side engagement portion; and
a hollow seal part including a bottom wall portion extending from said neck portion substantially linearly and substantially in parallel with said interior-side engagement portion of said mount base part, forming a predetermined space between said bottom wall portion and said interior-side engagement portion, and a seal wall provided on a side of said bottom wall portion which is opposite to a surface of said bottom wall portion facing said interior-side engagement portion.

According to (1), since the hollow portion includes the bottom wall portion, a gap with the predetermined space can be secured between the bottom wall portion of the hollow seal part and the interior-side engagement portion of the mount base part, which are in substantially parallel with each other, whereby even in case a relatively large hollow portion is formed, the likelihood of occurrence of a problem that the hollow seal part so formed overhangs the interior-side engagement portion to narrow the space therebetween is reduced, thereby facilitating the fitting of the interior-side engagement portion in the engagement recess of the mount portion. As a result, the increase in assemble performance of the weather strip can be improved. Furthermore, a relatively large hollow seal part can be formed, thereby making it possible to realize the increase in sealing property of the weather strip.

(2) In the weather strip of the invention, the mount base part may be made of a solid elastic material, and at least the seal wall of the hollow seal part may be made of a sponge elastic material.

According to (2), since the mount base part is made of a solid elastic material, the rigidity of the mount base part is increased, whereby the stability of the weather strip in an assembled state is increased. In addition, the neck portion becomes difficult to fall, whereby the maintenance of the gap between the bottom wall portion of the hollow seal part and the interior-side engagement portion, which are in substantially parallel with each other, is facilitated further.

(3) In the weather strip of the invention, the bottom wall portion of the hollow seal part may be made of a solid elastic material.

According to (3), the rigidity of the bottom wall portion of the hollow seal part is increased, whereby the maintenance of the gap between the bottom wall portion of the hollow seal part and the interior-side engagement portion is facilitated further. As a result, the functions and advantages provided by (1) can be obtained in a more ensured fashion.

(4) Another aspect of the invention provides a weather strip mounting structure, including:
the weather strip as described above; and
a mount portion having a pair of engagement recesses which are defined by a pair of interior-side and exterior-side fold back portions along a peripheral portion of a door of a vehicle;
wherein said interior-side engagement portion is fitted in said interior-side engagement recess by inserting a distal end portion of said interior-side fold back portion into the gap between said bottom wall portion and said interior-side engagement portion.

According to (4), by causing the weather strip to slide to the interior-side of the vehicle while keeping the distal end portion of the interior-side fold back portion in contact with the bottom wall portion of the hollow seal part, the interior-side engagement portion can be fitted in the interior-side engagement recess while inserting the distal end portion of the fold back portion within the gap. Consequently, the same functions and advantages as those of (1) are provided, thereby making it possible to realize the increase in assemble performance of the weather strip.

(5) In the weather strip mounting structure of the invention, a flat portion may be provided along the peripheral portion of the door of the vehicle, and
the mount portion may be provided in the vicinity of a distal end portion of the flat portion, and
a distal end portion of the bottom wall portion of the hollow seal part is brought into contact with the flat portion.

According to (5), by causing the weather strip to slide to the interior side of the vehicle while keeping the distal end portion of the bottom wall portion of the hollow seal part in contact with the flat portion, the interior-side engagement portion can befitted in the interior-side engagement recess while inserting the distal end portion of the fold back portion within the gap. As a result, a further increase in assemble performance of the weather strip can be realized.

### BRIEF DESCRIPTION OF THE DRAWINGS

FIG. 1 is a perspective view of an automobile whose front door is kept open;

FIG. 2 is a cross-sectional view taken along the line II-II in FIG. 1; and

FIG. 3 is a cross-sectional view of an extruded portion just after extrusion.

### DETAILED DESCRIPTION OF THE PREFERRED EMBODIMENTS

Hereinafter, one embodiment of the invention will be described by reference to the drawings.

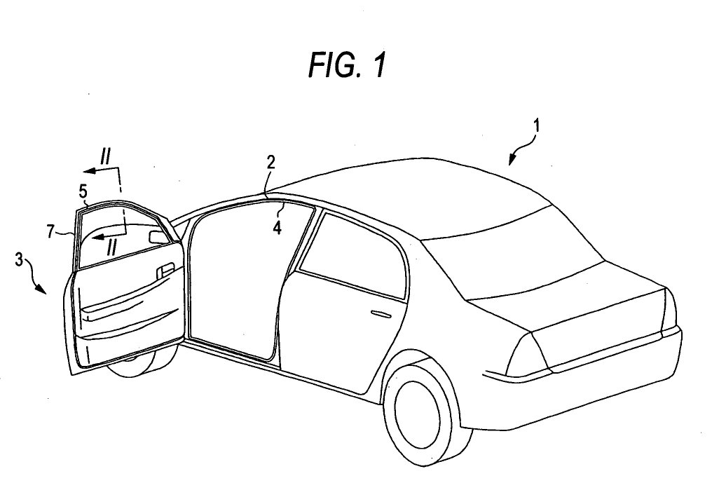

As shown in FIG. 1, an automobile door (in the figure, a front door; hereinafter, referred simply to as a door) 3 is provided in an opening 2 in an automobile body 1 as a vehicle (a vehicle main body) in such a manner as to be opened and closed. In addition, a weather strip 4 is securely mounted around the opening 2 in the automobile body 1 for establishing a seal between the automobile body 1 and the door 3. Similarly, a door weather strip 5 is securely mounted on the door 3 in such a manner as to conform to an outer peripheral shape of the door 3.

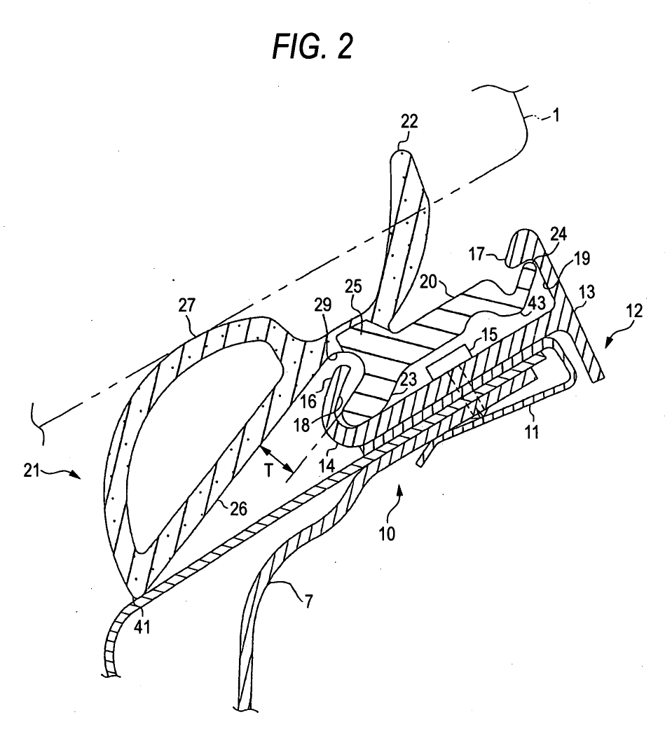

Next, referring to FIG. 2 which is a cross-sectional view of a portion of the door taken along the line II-II in FIG. 1, the configuration of the door weather strip 5 and a mounting structure thereof will be described in detail based on the configuration of a portion of a door frame 7.

The door frame 7 includes a flat portion 10 made up of two sheets of metal which is made to protrude toward an outside of the vehicle. A clip 11 is securely mounted at a distal end portion of the flat portion 10 for holding the two sheets of metal together. Furthermore, a frame molding 12 made of a hard resin material is securely mounted at a distal end portion of the flat portion 10.

The frame molding 12 is made up of an exterior-side wall portion 13 provided along an exterior-side side of the vehicle and a retainer portion 14, functioning as a mount portion, which protrudes from the exterior-side wall portion 13 toward an interior side of the vehicle substantially at right angles. Then, the frame molding 12 is fixed to the flat portion 10 by means of a clip 15 in such a state that the retainer portion 14 is provided on an upper surface of the flat portion 10.

In addition, a fold back portion 16 is formed at an interior-side end portion of the retainer portion 14 by bending the end portion toward an outside of the vehicle. On the other hand, a fold back portion 17 is formed at an upper end portion of the exterior-side wall portion 13 by bending the end portion toward the interior side of the vehicle. By adopting this configuration, the retainer portion 14 is formed into a shape with a substantially C-shaped cross section opening upwardly and includes a pair of interior-side and exterior-side engagement recesses 18, 19 which are defined by the pair of fold back portions 16, 17.

Next, the door weather strip 5 will be described. The door weather strip 5 is made up of an extruded portion that is formed substantially linearly (into an elongate shape) by an extruding machine, not shown, and a molded portion that is molded in such a manner as to be continuously connected to the extruded portion with a predetermined mold device by setting the extruded portion in such a manner as to connect an end thereof to a molded portion that will be molded.

The door weather strip 5 includes a mount base part 20 that is to be mounted in the retainer 14, and a hollow seal part 21 and a seal lip 22 which are formed integrally on the mount base part 20. In this embodiment, the mount base part 20 is made of an EPDM (ethylene-propylene-diene terpolymer) solid rubber as a solid elastic material, and the hollow seal part 21 and the seal lip 22 are made of an EPDM sponge rubber as a sponge elastic material.

To be more specific, the mount base part 20 is made up of an interior-side engagement portion 23 adapted to be brought into engagement with the interior-side engagement recess 18, an exterior-side engagement portion 24 adapted to be brought into engagement with the exterior-side engagement recess 19 and a neck portion 25 that is formed in such a manner as to protrude from a portion which substantially constitutes a boundary portion with a main body of the mount base part 20 and which is situated in the vicinity of the interior-side engagement portion 23.

In addition, the seal lip 22 is formed so as to extend from a distal end portion of the neck portion 25 toward the outside of the vehicle. On the other hand, the hollow seal part 21 is formed into a hollow shape by a bottom wall portion 26 that is formed in such a manner as to extend from the neck portion 25 toward the interior side of the vehicle substantially linearly and in substantially parallel with the interior-side engagement portion 23 with a predetermined space T kept with respect to the interior-side engagement portion 23 and a seal wall 27 with an arc-like cross section that is provided on a side of the bottom wall portion 26 which does not face the interior-side engagement portion 23. Then, a constricted portion 29, which functions as a gap, is formed on a side of the neck portion 25 which faces the interior side of the vehicle between the bottom wall portion 26 of the hollow seal part 21 and the interior-side engagement portion 23 of the mount base part 20.

Then, when mounting the door weather strip 5, which is configured as described above, in the retainer portion 14, by bringing a distal end portion of the interior-side fold back portion 16 into contact with the bottom wall portion 26 of the hollow seal part 21 while keeping a distal end portion of the bottom wall portion 26 in contact with the flat portion 10, the door weather strip is caused to slide toward the interior side of the vehicle. Then, the interior-side engagement portion 23 is fitted in the interior-side engagement recess 18 while inserting the distal end portion of the fold back portion 16 into the constricted portion 29. Next, the exterior-side engagement portion 24 is brought into engagement with the exterior-side engagement recess 19, and this completes the mounting. Then, with the door weather strip 5 so mounted, a state results in which a distal end portion 44 of the bottom wall portion 26 of the hollow seal part 21 is in contact with the flat portion 10.

Next, a manufacturing method of the above-described door weather strip 5 will be described. Firstly, the extruded portion is formed by a known extrusion using an extruding machine, not shown. Note that in an extruding step, a shape holding portion 30 is extruded together with the door weather strip 5 in such a state that the shape holding portion 30 is joined, respectively, to the bottom wall portion 26 of the hollow seal part 21 and the interior-side engagement portion 23 in order to maintain the space T at the constricted portion 29 in the extruded portion.

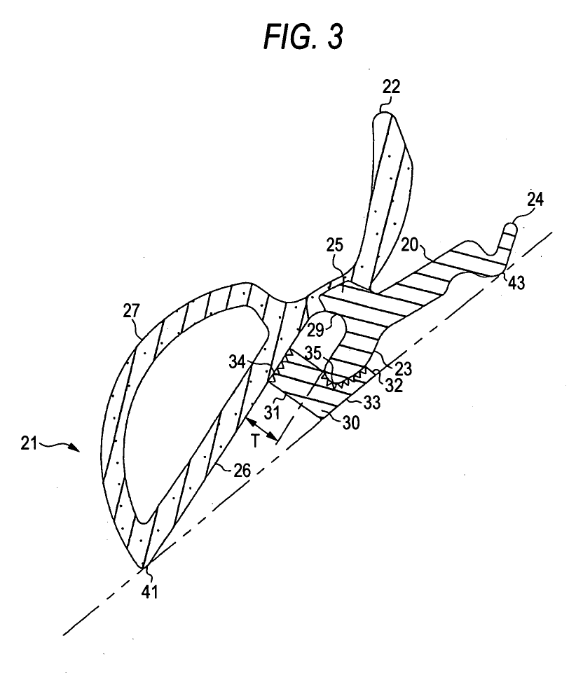

The shape holding portion 30 is made of an EPDM solid rubber and is made up of a main body portion 31 which is provided in such a manner as to intersect with the bottom wall portion 26 of the hollow seal part 21 at substantially right angles and a bottom surface support portion 32 which is made to extend from the main body portion 31 to cover a bottom surface of the interior-side engagement portion 23. In addition, a bottom surface 33 of the shape holding portion 30 is formed in such a manner as to follow a straight line which connects the distal end portion 41 of the bottom wall portion 26 of the hollow seal part 21 with a predetermined location on a bottom surface of the exterior-side engagement portion 24 (refer to FIG. 3).

According to the above structure, when placing the door weather strip (extruded portion) 5 after the extrusion, the door weather strip 5 can be supported at three points, and hence, the shape thereof can be maintained more stably.

In addition, a side of the main body portion 31 which faces the bottom wall portion 26 and a side of the bottom surface support portion 32, that is, joints (joining surfaces) 34, 35 with the bottom wall portion 26 and the interior-side engagement portion 23 are formed serrated as viewed sectionally by a plurality of ridges each having a substantially triangular cross section.

Then, the joining at the joint portion 34 with the bottom wall portion 26 of the hollow seal part 21 and the joint portion 35 with the interior-side engagement portion 23 are released. As this occurs, since the thickness of the respective joined locations of the joint portions 34, 35, which are formed substantially wavy, is sufficiently reduced, the shape holding portion 30 can easily be separated from the extruded portion manually or using a knife or the like.

Next, the extruded portion is set in the mold device (not shown), and then the molding of the molded portion is performed. Then, the door weather strip 5 is obtained in which the molded portion is connected to the extruded portion.

Thus, as described above in detail, by providing the bottom wall portion 26 of the hollow seal part 21, the constricted portion 29 with the predetermined space T can be secured between the bottom wall portion 26 of the hollow seal part 21 and the interior-side engagement portion 23 of the mount base part 20 which are substantially parallel to each other, whereby even in the event that the hollow seal part 21 is formed relatively large as in the case of this embodiment, the likelihood of occurrence of the problem that the hollow seal part 21 overhangs the interior-side engagement portion 23 to narrow the space therebetween is reduced, so that the interior-side engagement portion 23 is easily fitted in the interior-side engagement recess 18 of the retainer portion 14. As a result, the increase in assemble performance of the door weather strip 5 can be realized. Furthermore, the hollow seal part 21 can be formed relatively largely, thereby making it possible to realize the increase in sealing property of the door weather strip 5.

In addition, when forming the extruded portion, since the shape holding portion 30 is extruded together with the extruded portion, the likelihood of occurrence of the problem that the hollow seal part 21 sags to thereby attach to the mount base part 20 during extrusion or that the hollow seal part 21 overhangs the interior-side engagement portion 23 to thereby narrow the space therebetween can be reduced. Furthermore, when compared with a case where the shape holding portion 30 is not extruded together with the extruded portion but is mounted thereon after the extrusion of the extruded portion, the likelihood of occurrence of not only the aforesaid problem but also another problem that the production costs are increased or the manufacturing steps are made complex can be reduced.

Additionally, since the main body portion 31 of the shape holding portion 30 is provided in such a manner as to intersect with the bottom wall portion 26 of the hollow seal part 21 at substantially right angles, the bottom wall portion 26 can be supported in a more ensured fashion. Furthermore, since the bottom surface support portion 32 is provided in such a manner as to extend from the main body portion 31 to cover the bottom surface of the interior-side engagement portion 23, the joining surface (joint) with the bottom surface of the interior-side engagement portion 23 can be secured relatively largely. As a result, the space between the bottom wall portion 26 and the interior-side engagement portion 23 can be maintained in a more ensured fashion. In addition, since the respective joint portions 34, 35 are provided outside the constricted portion 29, when compared with a case where the joint portions 34, 35 are provided within the constricted portion 29, the releasing work of the shape holding portion 30 can be performed more easily. As a result, the increase in workability can be realized.

Note that the embodiment of the invention is not limited to what has been described heretofore but may be implemented as below, for example. It goes without saying that other applications and modifications than those that will be described below are, of course, acceptable.

(a) While in the embodiment, the door weather strip 5 is described as being applied to the front door 3 specifically, the location of the door to which the door weather strip 5 is attached is not limited thereto, and hence, the door weather strip 5 can be applied to, for example, a rear door.

(b) While in the embodiment, the door weather strip 5 is made of EPDM, it may be made of another material such as olefin thermoplastic elastomer (TPO).

(c) While in the embodiment, the whole of the hollow seal part 21 is made of EPDM sponge rubber, the material configuration is not limited thereto, and at least the seal wall 27 of the hollow seal part 21 only has to be made of EPDM sponge rubber (sponge elastic material), and hence, for example, the bottom wall portion 26 of the hollow seal part 21 may be made of a solid elastic material. By adopting this configuration, the rigidity of the bottom wall portion 26 of the hollow seal part 21 is increased, whereby the maintenance of the gap between the bottom wall portion 26 of the hollow seal part 21 and the interior-side engagement portion 23 is facilitated further.

(d) The configuration of the shape holding portion 30 is not limited to what has been described in the embodiment. For example, a configuration may be adopted in which the shape holding portion is provided within the constricted portion 29, or a configuration may be adopted in which the bottom surface support portion 32 may be omitted which extends to cover the bottom surface of the interior-side engagement portion 23. In addition, the bottom surface 33 of the shape holding portion 30 may not be formed in such a manner as to follow the straight line which connects the distal end portion 41 of the bottom wall portion 26 of the hollow seal part 21 with the predetermined location 43 on the bottom surface of the exterior-side engagement portion 24. Furthermore, the joint portions 34, 35 with the bottom wall portion 26 and the interior-side engagement portion 23 may not be formed into the shape with a wavy cross section.

What is claimed is:

1. A weather strip adapted to be mounted on a door of a vehicle, comprising:
a mount base part including an interior-side engagement portion and an exterior-side engagement portion which are engageable with a pair of engagement recesses provided on a mount portion of a door, and a neck portion extending from said interior-side engagement portion or a vicinity of said interior-side engagement portion; and
a hollow seal part including a bottom wall portion extending from said neck portion substantially linearly and substantially in parallel with said interior-side engagement portion of said mount base part, forming a predetermined space between said bottom wall portion and said interior side engagement portion and a seal wall provided on a side of said bottom wall portion which is opposite to a surface of said bottom wall portion facing said interior-side engagement portion.

2. A weather strip according to claim 1, wherein said mount base part is made of a solid elastic material, and at least said seal wall of said hollow seal part is made of a sponge elastic material.

3. A weather strip according to claim 2, wherein said bottom wall portion of said hollow seal part is made of a solid elastic material.

4. A weather strip according to claim 1 further comprising a seal lip extending from said neck portion to an outside of said vehicle.

5. A weather strip according to claim 4, wherein said seal lip is made of a sponge elastic material.

6. A weather strip mounting structure, comprising:
the weather strip according to claim 1; and
a mount portion having a pair of engagement recesses which are defined by a pair of interior-side and exterior-side fold back portions along a peripheral portion of a door of a vehicle;
wherein said interior-side engagement portion is fitted in said interior-side engagement recess by inserting a distal end portion of said interior-side fold back portion into a gap between said bottom wall portion and said interior-side engagement portion.

7. A weather strip mounting structure according to claim 6, wherein a flat portion is provided along said peripheral portion of said door of said vehicle so that said mount portion is in a vicinity of a distal end portion of said flat portion, and
a distal end portion of said bottom wall portion is brought into contact with said flat portion.
